(19) United States
(12) Patent Application Publication
(10) Pub. No.: US 2015/0229778 A1
(43) Pub. Date: Aug. 13, 2015

(54) OFFLINE CHARGING FOR RICH COMMUNICATION SERVICES (RCS)

(71) Applicant: ALCATEL-LUCENT USA INC., Murray Hill, NJ (US)

(72) Inventors: Ranjan Sharma, New Albany, OH (US); Yigang Cai, Naperville, IL (US)

(73) Assignee: ALCATEL-LUCENT USA INC., Murray Hill, NJ (US)

(21) Appl. No.: 14/179,522

(22) Filed: Feb. 12, 2014

(51) Int. Cl. H04M 15/00

(52) U.S. Cl. CPC H04M 15/61; H04M 15/57; H04M 15/65

(57) ABSTRACT

Systems and methods that provide charging for Rich Communication Services (RCS). One embodiment comprises an offline charging system that receives a Diameter charging request from a network element that provides a Rich Communication Services (RCS) service. The offline charging system processes an Attribute Value Pair (AVP) of the Diameter charging request to identify an RCS service Identifier (ID) that uniquely identifies the RCS service. The offline charging system selects RCS charging logic for the RCS service based on the RCS service ID, and initiates the RCS charging logic to charge for the RCS service.

### TECHNICAL FIELD

The present disclosure is related to the field of communication systems and, in particular, to charging for Rich Communication Services (RCS).

### BACKGROUND

Rich Communication Services (RCS) are a suite of services defined by the GSM Association (GSMA) that enhance the way end users are able to communicate. RCS services extend beyond typical voice and text messaging by providing instant messaging, chat, presence, live video, file sharing, etc., across any device on any network. For example, an end user may be able to view presence information for a contact in his/her mobile phone through RCS. In another example, an end user may engage in a 1-on-1 chat session with another, and exchange files during the chat session using RCS. A further listing of services provided in RCS is as follows: Social Presence, Standalone Messaging, 1-to-1 chat, Group chat, Disposition Notification, File transfer 1-to-1, File transfer in group chat, File transfer with HTTP, Video Share, Video Share Phase II, Image share, IP Voice Call, IP Video Call, Geo Location PUSH, Geo Location PULL using LBS, Geo Loc PULL using File Xfer, and Show us on a map.

RCS utilizes the IP Multimedia Subsystem (IMS) domain as specified by 3rd Generation Partnership Project (3GPP) to perform a number of key functions such as handling of SIP signaling, authentication, authorization, and charging/routing support. However, one issue with implementing RCS over IMS is that offline charging can be a challenge. The IMS domain includes an offline charging system that is able to perform offline charging for services. However, there is no effective way to charge for individual RCS services using the offline charging system of the IMS domain.

### SUMMARY

Embodiments described herein provide more effective charging for RCS services. GSMA specifies (see GSMA IR.90) that an RCS service should be identified by parsing the P-Asserted-Service header of a SIP message according to 3GPP TS 24.229. Prior to the description provided herein, not all RCS services had a standardized P-Asserted-Service value that uniquely identified the RCS service. Therefore, the value inserted in the P-Asserted-Service header of a SIP message may not have indicated a particular type of RCS service being provided. Also, there was no effective way to pass an indication of the RCS service being requested to an offline charging system so that the offline charging system could charge for the RCS service.

The embodiments described herein define a unique RCS service identifier (ID) for each of the RCS services, so that the RCS services can be distinguished from one another in a charging system. The embodiments also define a new Diameter Attribute Value Pair (AVP) for the RCS service IDs. When an application server or another type of network element provides an RCS service, the network element generates a charging request for the RCS service. The network element may then insert the RCS service ID in the new Diameter AVP of the charging request, and send the charging request to an offline charging system. The offline charging system may then charge for the RCS service based on the RCS service ID.

One embodiment comprises an offline charging system configured to receive a Diameter charging request from a network element that provides an RCS service. The offline charging system is configured to process an Attribute Value Pair (AVP) of the Diameter charging request to identify an RCS service ID that uniquely identifies the RCS service. The offline charging system is further configured to select RCS charging logic for the RCS service based on the RCS service ID, and to initiate the RCS charging logic to charge for the RCS service.

In another embodiment, the attribute name of the new AVP comprises “RCS-Service-Id”, the code of the new AVP comprises “200”, and the data type of the new AVP comprises “Enumerated”. One example of the Diameter charging request is a Diameter Rf Accounting Request (ACR). A Diameter Rf ACR and other types of charging requests are configured to carry information for a single RCS service.

In another embodiment, the RCS charging logic includes one or more Service—Independent Blocks (SIB) to process in order to charge for the RCS service.

Another embodiment comprises a method for charging for RCS services. The method includes receiving a Diameter charging request in an offline charging system from a network element that provides an RCS service. The method further includes processing an AVP of the Diameter charging request in the offline charging system to identify an RCS service ID for the RCS service that uniquely identifies the RCS service. The method further includes selecting RCS charging logic for the RCS service based on the RCS service ID, and initiating the RCS charging logic in the offline charging system to charge for the RCS service.

Another embodiment comprises an IP Multimedia Subsystem (IMS) application server (AS) configured to detect a chargeable event for an RCS service, and to generate a Diameter charging request in response to the chargeable event to report charging information to an offline charging system. The IMS AS is configured to identify an RCS service ID for the RCS service that uniquely identifies the RCS service, to insert the RCS service ID in an AVP of the Diameter charging request, and to transmit the charging request to the offline charging system.

Another embodiment comprises an offline charging system configured to receive a first charging request from a first network element for an RCS service, and to receive a second charging request from a second network element for a non-RCS service. The offline charging system is configured to select a first charging workflow for the RCS service to generate a first Charging Data Record (CDR) for the RCS service, and to select a second charging workflow to generate a second CDR for the non-RCS service. The offline charging system is configured to determine whether to synchronize the first charging workflow with the second charging workflow, and to correlate the first CDR with the second CDR responsive to a determination to synchronize the charging workflows.

Other exemplary embodiments may be described below.

### DESCRIPTION OF THE DRAWINGS

Some embodiments of the disclosure are now described, by way of example only, and with reference to the accompanying drawings. The same reference number represents the same element or the same type of element on all drawings.

FIG. 1 illustrates a communication network in an exemplary embodiment.

FIG. 2 is a block diagram of an IMS application server (AS) in an exemplary embodiment.

FIG. 3 is a flow chart illustrating a method for reporting charging information for an RCS service to an offline charging system (OFCS) in an exemplary embodiment.

FIG. 4 is a flow chart illustrating a method for charging for an RCS service in an exemplary embodiment.

FIG. 5 illustrates initial selection of a charging workflow in an exemplary embodiment.

FIG. 6 illustrates a charging workflow for RCS services in an exemplary embodiment.

FIG. 7 illustrates charging logic for different RCS services in another exemplary embodiment.

FIG. 8 illustrates synchronization of workflows in an exemplary embodiment.

### DESCRIPTION OF EMBODIMENTS

The figures and the following description illustrate specific exemplary embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

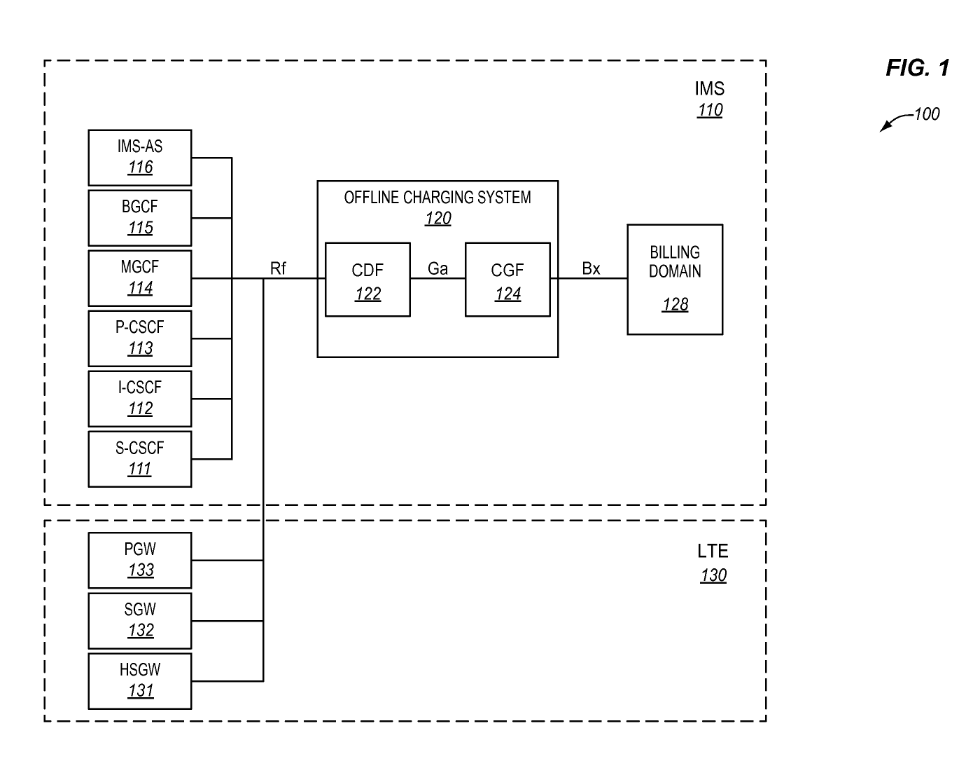

FIG. 1 illustrates a communication network 100 in an exemplary embodiment. Communication network 100 represents the network of a carrier or service provider that offers services, such as RCS services. In this embodiment, network 100 includes an IP Multimedia Subsystem (IMS) domain 110 and a Long Term Evolution (LTE) domain 130. These domains are provided as an example, and any other type of network that provides RCS services or non-RCS services may be used.

IMS domain 110 includes a Serving-Call Session Control Function (S-CSCF) 111, an Interrogating-Call Session Control Function (I-CSCF) 112, a Proxy-Call Session Control Function (P-CSCF) 113, a Media Gateway Controller Function (MGCF) 114, a Breakout Gateway Controller Function (BGCF) 115, and an IMS application server (AS) 116. Although not specifically shown in FIG. 1, IMS domain 110 may include more network elements that are not shown. IMS domain 110 also includes an Offline Charging System (OFCS) 120 and a billing domain 128. IMS application server (AS) 116 comprises any server, device, or network element configured to host and execute services, which include RCS services in this embodiment. Although one AS is shown in FIG. 1, IMS domain 110 may include many application servers that are able to provide RCS services and other types of services.

OFCS 120 comprises any server, device, or network element configured to implement offline charging for sessions or services provided to an end user. OFCS 120 is configured to receive charging events (also referred to as charging requests or accounting requests for offline charging) from network elements (e.g., IMS AS 116), and process the charging information for the charging events to construct Charging Data Records (CDRs). The purpose of offline charging is to transform the charging information into CDRs that are post-processed within billing domain 128 for the purpose of generating bills. The network elements of IMS domain 110 are coupled to OFCS 120 over a Diameter Rf interface.

OFCS 120 includes a Charging Data Function (CDF) 122 and a Charging Gateway Function (CGF) 124. CDF 122 comprises an element or module within OFCS 120 that receives charging events from Charging Trigger Functions (CTF) within network elements of IMS domain 110, such as IMS AS 116. CDF 122 formats the charging events in CDRs, and forwards the CDRs to CGF 124, such as over a Ga reference point. CGF 124 comprises an element or module within OFCS 120 that correlates CDRs for a session, and forwards a correlated CDR to billing domain 128, such as over a Bx reference point. The OFCS architecture shown in FIG. 1 is just one example, as OFCS 120 may include a Charging Collector Function (CCF) in another embodiment, or may include other functions to perform offline charging.

LTE domain 130 includes an HRPD Serving Gateway (HSGW) 131, a Serving Gateway (SGW) 132, and a Packet Data Network Gateway (PGW) 133. The network elements in LTE domain 130 are also coupled to OFCS 120 over the Diameter Rf interface. LTE domain 130 may include more network elements that are not shown in FIG. 1.

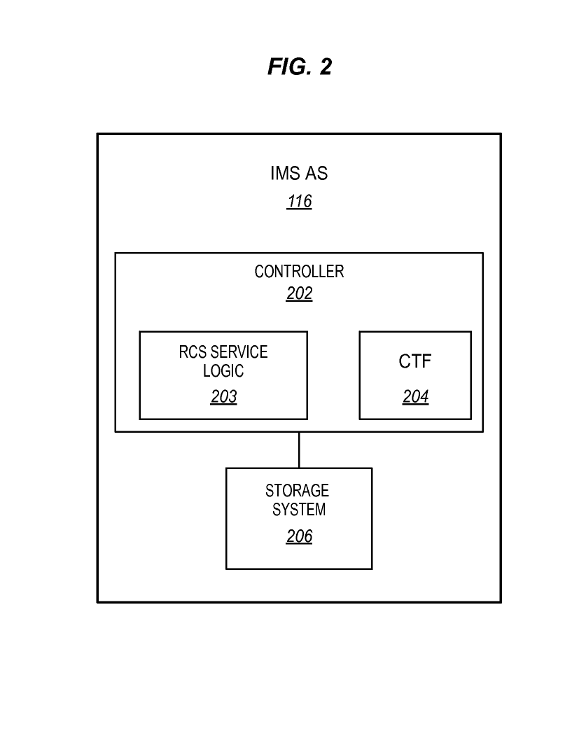

IMS domain 110 is able to establish and maintain sessions for User Equipment (UE) of end users to allow the UE's to access services, such as RCS services. In the embodiments described below, IMS AS 116 is configured to provide one or more RCS services for a data session over IMS domain 110. FIG. 2 is a block diagram of IMS AS 116 in an exemplary embodiment. IMS AS 116 includes a controller 202 (including a processor) that provides services, including RCS services. For example, controller 202 may execute RCS service logic 203 in order to provide RCS services. Controller 202 also provides a Charging Trigger Function (CTF) 204. A CTF comprises any element or module that generates charging events based on the observation of network resource usage. The CTF is the focal point for collecting information pertaining to chargeable events within a network element, assembling this information into matching charging events, and sending these charging events towards a charging function in the form of charging requests or accounting requests. IMS AS 116 also includes a storage system 206 for storing data, such as a memory. IMS AS 116 may include other elements or modules that are not shown in FIG. 2 to provide services.

Assume for the following embodiment that a UE registers with IMS domain 110, and initiates a data session (see FIG. 1). During the data session, further assume that the UE requests an RCS service. For example, the UE may request a group chat with other users. To request the RCS service, the UE may transmit a SIP INVITE requesting the RCS service, which is received by S-CSCF 111. S-CSCF 111 processes the SIP INVITE to determine the type of RCS service requested. The assumption is that IMS AS 116 provides the requested RCS service, so S-CSCF 111 forwards the SIP INVITE to IMS AS 116. IMS AS 116 then processes the SIP INVITE, and initiates the RCS service.

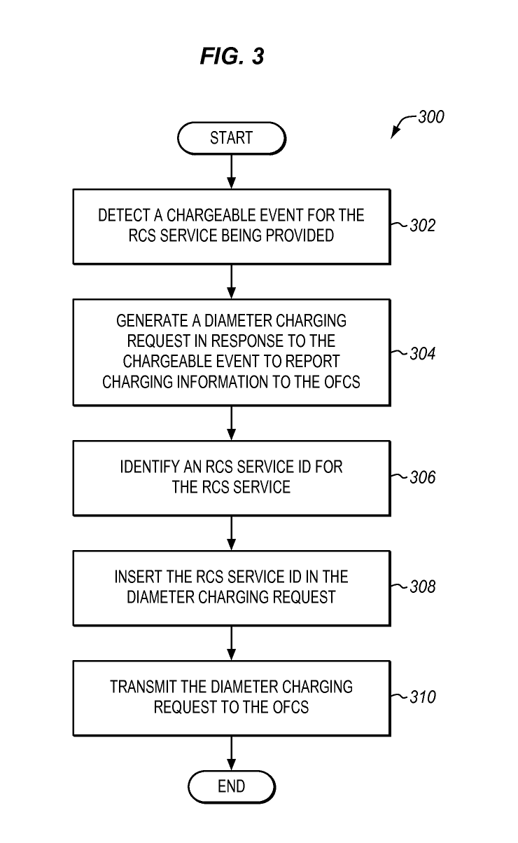

IMS AS 116 executes RCS service logic 203 to initiate the RCS service. Also, CTF 204 within IMS AS 116 (see FIG. 2) initiates processes to charge for the RCS service. A description of the charging process is illustrated in FIG. 3

FIG. 3 is a flow chart illustrating a method 300 for reporting charging information for an RCS service to OFCS 120 in an exemplary embodiment. The steps of method 300 will be described with reference to IMS AS 116 in FIG. 1, but those skilled in the art will appreciate that method 300 may be performed in other systems. Also, the steps of the flow charts described herein are not all inclusive and may include other steps not shown, and the steps may be performed in an alternative order.

In step 302, CTF 204 within IMS AS 116 detects a chargeable event for the RCS service being provided to the UE. In step 304, CTF 204 generates a charging request in response to the chargeable event to report charging information to OFCS 120. The charging request generated by CTF 204 is a Diameter charging request, such as a Diameter Rf Accounting Request (ACR). Although Diameter is discussed in this embodiment, different charging protocols may be used in other embodiments.

In step 306, CTF 204 identifies an RCS service ID for the RCS service. The RCS service ID comprises any type of identifier (e.g., number, string, etc.) that uniquely indicates or specifies the RCS service being requested or provided. Thus, there is a unique RCS service ID for each RCS service available to end users. The RCS service IDs may be specified by a standards organization, may be specified by a carrier/vendor, or may be specified in another manner.

To identify the RCS service ID, CTF 204 may process the P-Asserted-Service header of a SIP INVITE or another type of SIP message received for the data session. The P-Asserted-Service header typically includes a service ID parameter for the service being requested for a session. Therefore, the P-Asserted-Service header may include the RCS service ID for the RCS service being requested. CTF 204 may also parse other fields of a SIP message to identify the RCS service ID.

In step 308, CTF 204 inserts the RCS service ID in the charging request. To insert the RCS service ID in the charging request, new fields or parameters may be defined in the charging request. For example, a new Attribute Value Pair (AVP) may be defined in Diameter for the RCS service ID. The new AVP may be formatted as follows:

Attribute-Name: RCS-Service-Id;

Code: 200;

Data type: Enumerated (ENUM).

CTF 204 also inserts other charging information for the RCS service into the charging request, such as origin information, destination information, session ID, etc. The charging request in this embodiment carries information for a single RCS service that is uniquely identified by the RCS service ID. For example, a Diameter Rf ACR would include charging information for a single RCS service, such as a “group chat”. In step 310, CTF 204 transmits the charging request to OFCS 120 via the Rf reference point.

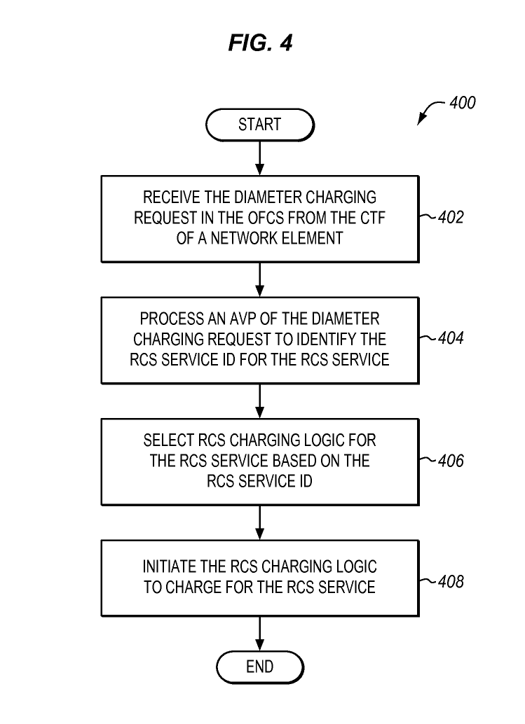

OFCS 120 may then process the charging request to charge for the RCS service. FIG. 4 is a flow chart illustrating a method 400 for charging for an RCS service in an exemplary embodiment. The steps of method 400 will be described with reference to OFCS 120 in FIG. 1, but those skilled in the art will appreciate that method 400 may be performed in other systems.

In step 402, OFCS 120 receives the charging request from CTF 204 (of IMS AS 116), such as in CDF 122 as shown in FIG. 1. OFCS 120 then parses the charging request to identify the RCS service ID for the RCS service provided by IMS AS 116. More particularly, OFCS 120 is programmed to process one or more new AVP of the charging request in step 404 to identify the RCS service ID. OFCS 120 is therefore able to determine which RCS service has been requested/provided based on the RCS service ID.

In step 406, OFCS 120 selects RCS charging logic for the RCS service based on the RCS service ID. There may be different RCS charging logic available within OFCS 120 for the different RCS services. Therefore, OFCS 120 selects which RCS charging logic to use in charging for the RCS service based on the RCS service ID. OFCS 120 then initiates the RCS charging logic to charge for the RCS service in step 408. The RCS charging logic generates a CDR for the RCS service, which OFCS 120 will subsequently pass to billing domain 128.

Because IMS AS 116 is able to pass the RCS service ID to OFCS 120 in a Diameter charging request, OFCS 120 is able to identify which RCS service is being provided, and is able to charge for that RCS service accordingly. This allows service providers to offer RCS services to its subscribers, and to accurately charge for the services that are provided.

The following describes embodiments for selecting and/or executing RCS charging logic to charge for RCS services. OFCS 120 is able to associate RCS charging logic with the RCS service ID provided in the charging request from IMS AS 116 (or other network elements). Conditional execution of logical branches may require incorporation of Decision Points (DPs). The outcome of a decision point evaluation may result in selecting a branch of RCS charging logic which correspond with the RCS service ID.

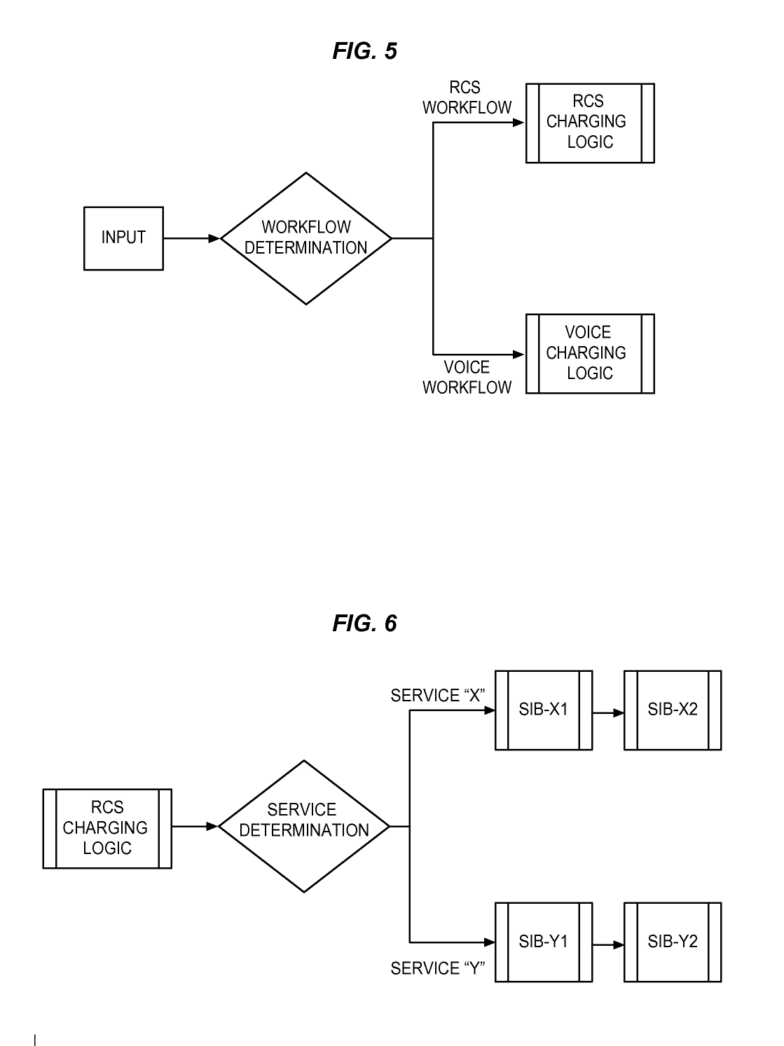

FIG. 5 illustrates initial selection of a charging workflow in an exemplary embodiment. A charging workflow comprises logic within OFCS 120 that is executed in order to process data from a charging request (e.g., ACR) and generate a Charging Data Record (CDR). When receiving a charging request, OFCS 120 may select between multiple charging workflows in order to process the charging request. For example, there may be a charging workflow for RCS services as described herein, and additional charging workflows for voice services, video services, audio services, or any other non-RCS service.

In FIG. 5, the selection of workflows is between a voice service and an RCS service. In FIGS. 1-4, it was assumed that an RCS service was provided by IMS AS 116. In this embodiment, OFCS 120 may receive a charging request from any network element, and it does not know whether the charging request is for an RCS service or another type of service. Therefore, in response to receiving a charging request, OFCS 120 first determines whether the service type is for a non-RCS service (e.g., a voice service) or an RCS service (e.g., group chat). If the service type is for an RCS service, then OFCS 120 selects a charging workflow for RCS services, which includes the RCS charging logic for charging for the RCS service. If the service type is for a non-RCS service (e.g., a voice service), then OFCS 120 selects a charging workflow which includes the charging logic for charging for the non-RCS service (e.g., voice service).

FIG. 6 illustrates a charging workflow for RCS services in an exemplary embodiment. Within the workflow for RCS services, OFCS 120 selects which charging logic to use based on the RCS service ID provided in the charging request. In this example, two different sets of charging logic are illustrated for services “X” and “Y”, although more services may be implemented. The charging logic for service “X” includes Service-Independent Blocks (SIB) X1 and X2. The charging logic for service “Y” includes SIBs Y1 and Y2. The SIBs represent the processing blocks within the charging logic. Some examples of SIBs are: Rf Adaptor, Ga Adaptor, Validation, VxQuery, HSSQuery, LocalMapping, Aggregation, Pre-correlation, Correlation, Pre-Biller, and Distributor.

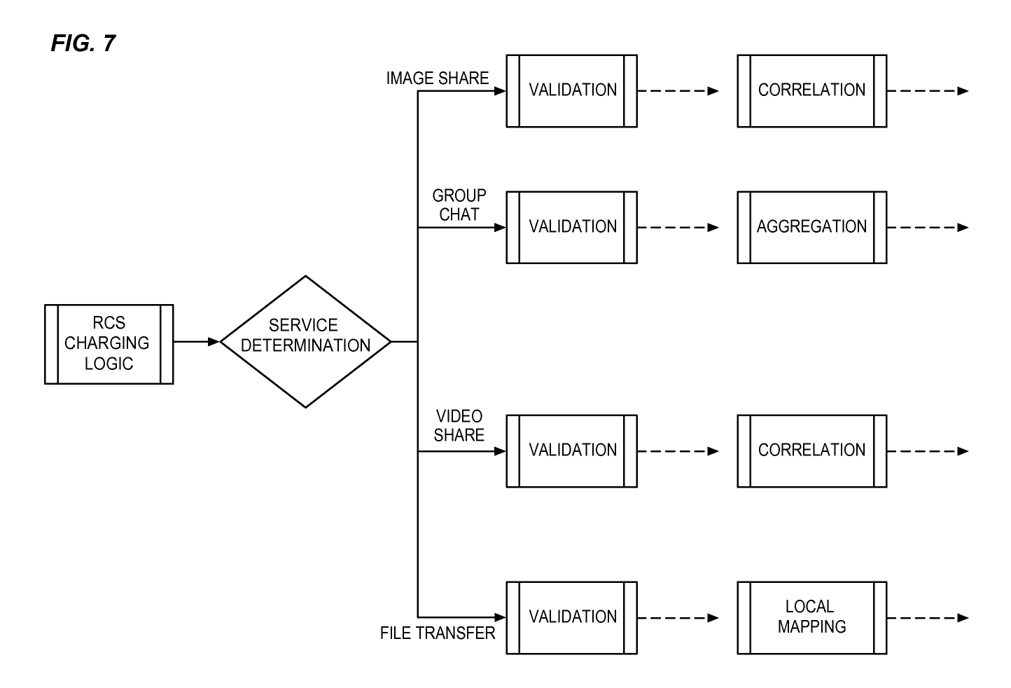

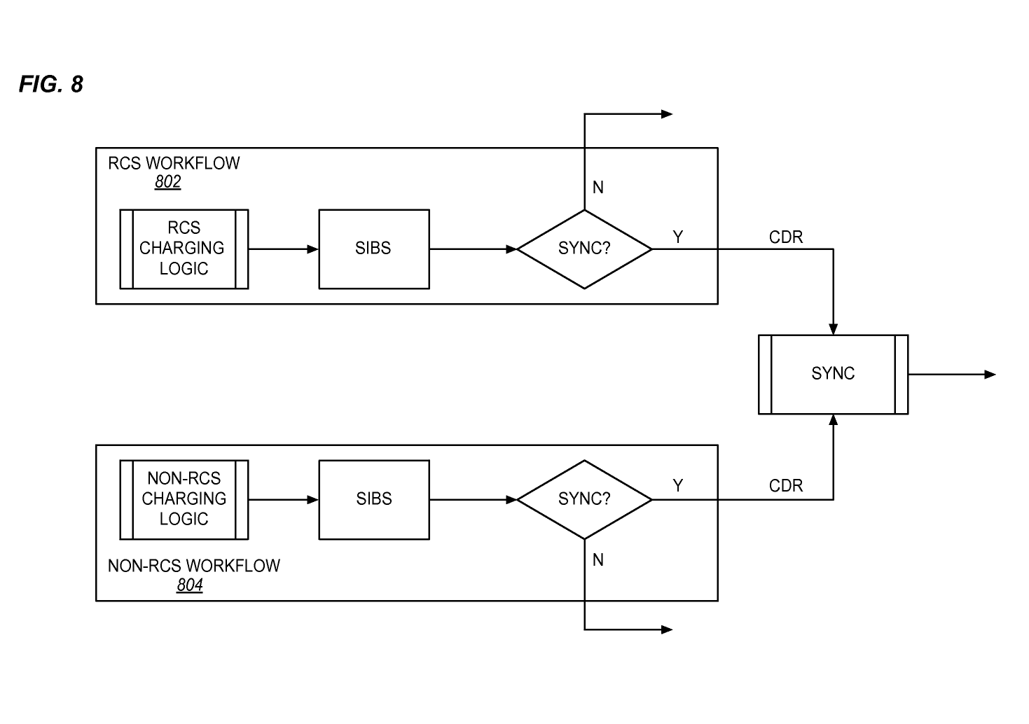

FIG. 7 illustrates charging logic for different RCS services in another exemplary embodiment. In FIG. 7, four services are illustrated with different charging logic. The services illustrated are “image share”, “group chat”, “video share”, and “file transfer”. For each of these services, a different branch of charging logic exists. For example, the video share service uses a “correlation” SIB, while a chat service does not. The chat service uses an “aggregation” SIB, while the other services do not. There are no strict rules about inclusion or exclusion of SIBs in different branches. In practice however, it is expected that the SIBs and their sequence within different branches would differ.

The determination of the processing branch is keyed on one or more AVPs present in the charging request (e.g., ACR) received in OFCS 120. As services are added, the range of values in these AVPs would change. For instance, if the initial roll-out had services 1 through 5, then there would be five branches assuming each service took a different processing branch. Subsequently, upon adding two more services, the value represented in the AVPs would encompass these additional services and correspondingly, potentially two more processing branches may be added.

Just like addition of services, services may be dropped or swapped. When a service is dropped, the branch coming out of the decision point may be removed from OFCS 120. When a service is swapped, the operator replaces the service identification with a new one.

Looking again at FIG. 6, a “branch” is one of several alternative paths of a workflow that is selected for execution following evaluation of a DP (decision point). A “span” is a sequence of two or more SIBs within a branch (without involving a DP). The overall relationship is as follows:
The OFCS provides the framework to run one or more workflows;
A workflow represents the charging logic, starting with the input (e.g., charging request) and finishing with a CDR;
A workflow includes one or more branches;
A workflow with a single branch includes one or more SIBs executed sequentially;
A workflow with more than one branch includes at least one decision point (DP) that selects the branch to be executed based on evaluation criterion;
A branch includes zero or more spans, and additionally, zero or more SIBs;
A span consists of two or more SIBs;

The purpose for defining a span is to get a sequence of SIBs as an addressable unit, which simplifies operator manipulation of the charging logic.

There may be instances where synchronization is desired between two different workflows within OFCS 120. For example, assume that a voice session is established between two end users. During the voice session, if one of the users wants to share a video, then an RCS service may be invoked to share the video (“video share”). In this type of scenario, OFCS 120 receives charging requests from a network element (e.g., SGW 132) that serves the voice session, and OFCS 120 receives charging requests from a network element (e.g., IMS-AS 116) that provides the RCS service. In response to the charging requests, OFCS 120 will select a different workflow for the RCS service (e.g., video share) and the non-RCS service (e.g., voice session). It may be desirable for OFCS 120 to synchronize these workflows when performing offline charging.

FIG. 8 illustrates synchronization of workflows in an exemplary embodiment. In this embodiment, OFCS 120 selects an RCS workflow 802 to charge for the RCS service. OFCS 120 also selects a non-RCS workflow 804 to charge for the non-RCS service (e.g., voice session). In executing the RCS workflow 802, OFCS 120 generates a CDR for the RCS service. Likewise, in executing the non-RCS workflow 804, OFCS 120 generates a CDR for the non-RCS service.

When processing the RCS workflow 802 and/or non-RCS workflow 804, OFCS 120 determines whether to synchronize the RCS workflow 802 with the non-RCS workflow 804. The determination of whether or not to synchronize the workflows is configurable by the service provider.

If the determination is to synchronize the workflows, then OFCS 120 correlates the RCS CDR with the non-RCS CDR. To correlate the CDRs, OFCS 120 combines data from the CDRs to generate a correlated CDR. This correlated CDR may then be provided to the billing domain 128 (see FIG. 1) so that the billing domain 128 can resolve charges for the services.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the disclosure is not limited to those specific embodiments. The scope of the disclosure is defined by the following claims and any equivalents thereof.

We claim:

1. An apparatus comprising:
an offline charging system including a processor configured to receive a Diameter charging request from a network element that provides a Rich Communication Services (RCS) service;
the offline charging system is configured to process an Attribute Value Pair (AVP) of the Diameter charging request to identify an RCS service Identifier (ID) that uniquely identifies the RCS service, to select RCS charging logic for the RCS service based on the RCS service ID, and to initiate the RCS charging logic to charge for the RCS service.

2. The apparatus of claim 1 wherein:
the attribute name of the AVP comprises “RCS-Service-Id”;
the code of the AVP comprises “200”; and
the data type of the AVP comprises “Enumerated”.

3. The apparatus of claim 1 wherein:
the Diameter charging request comprises a Diameter Rf Accounting Request (ACR).

4. The apparatus of claim 1 wherein:
the Diameter charging request is configured to carry information for a single RCS service.

5. The apparatus of claim 1 wherein:
the RCS charging logic includes at least one Service-Independent Block (SIB) to process in order to charge for the RCS service.

6. The apparatus of claim 1 wherein:
the network element comprises an IP Multimedia Subsystem (IMS) application server (AS) that provides the RCS service.

7. A method for charging for Rich Communication Services (RCS), the method comprising:
receiving a Diameter charging request in an offline charging system from a network element that provides a Rich Communication Services (RCS) service;
processing an Attribute Value Pair (AVP) of the Diameter charging request in the offline charging system to identify an RCS service Identifier (ID) that uniquely identifies the RCS service;
selecting RCS charging logic for the RCS service based on the RCS service ID; and
initiating the RCS charging logic in the offline charging system to charge for the RCS service.

8. The method of claim 7 wherein:
the attribute name of the AVP comprises “RCS-Service-Id”;
the code of the AVP comprises “200”; and
the data type of the AVP comprises “Enumerated”.

9. The method of claim 7 wherein:
the Diameter charging request comprises a Diameter Rf Accounting Request (ACR).

10. The method of claim 7 wherein:
the Diameter charging request is configured to carry information for a single RCS service.

11. The method of claim 7 wherein:
the RCS charging logic includes at least one Service-Independent Block (SIB) to process in order to charge for the RCS service.

12. The method of claim 7 wherein:
the network element comprises an IP Multimedia Subsystem (IMS) application server (AS) that provides the RCS service.

13. An apparatus comprising:
an offline charging system comprising a processor configured to receive a first charging request from a first network element for a Rich Communication Services (RCS) service, and to receive a second charging request from a second network element for a non-RCS service;
the offline charging system is configured to select a first charging workflow for the RCS service to generate a first Charging Data Record (CDR) for the RCS service, and to select a second charging workflow to generate a second CDR for the non-RCS service;
the offline charging system is configured to determine whether to synchronize the first charging workflow with the second charging workflow, and to correlate the first CDR with the second CDR responsive to a determination to synchronize the charging workflows.

14. The apparatus of claim 13 wherein:
the first charging request comprises a Diameter Rf Accounting Request (ACR).

15. The apparatus of claim 14 wherein:
the offline charging system is configured to process an Attribute Value Pair (AVP) of the Diameter ACR to identify an RCS service Identifier (ID) that uniquely identifies the RCS service, to select RCS charging logic in the first charging workflow based on the RCS service ID, and to initiate the RCS charging logic to generate the first CDR for the RCS service.

16. The apparatus of claim 15 wherein:
the attribute name of the AVP comprises “RCS-Service-Id”;
the code of the AVP comprises “200”; and
the data type of the AVP comprises “Enumerated”.
